(19) United States
(12) Patent Application Publication
(10) Pub. No.: US 2005/0137022 A1
(43) Pub. Date: Jun. 23, 2005

(54) Apparatus and method for friction welded tripod interconnecting shaft

(76) Inventors: Donald E. Neeley, Sanford, NC (US); Andre D. Olivier, Raleigh, NC (US)

Correspondence Address: GKN DRIVELINE NORTH AMERICA, INC, 3300 UNIVERSITY DRIVE, AUBURN HILLS, MI, 48326, US

(21) Appl. No.: 10/742,180

(22) Filed: Dec. 19, 2003

(51) Int. Cl. F16D 3/26

(52) U.S. Cl. 464/111

(57) ABSTRACT

A unitary tripod shaft for torque transmission includes an interconnecting shaft and a tripod body welded together to form a propeller shaft assembly. The tripod body has an end co-axially fixed to an end of the interconnecting shaft and three circumferentially spaced trunions extending therefrom. The tripod body is welded to the interconnecting shaft. A method of making the unitary tripod shaft is also provided.

### TECHNICAL FIELD

The present invention relates generally to motor vehicle propeller shafts, and more particularly concerns a unitary constant velocity joint and interconnecting shaft.

### BACKGROUND OF THE INVENTION

Constant velocity joints and interconnecting shafts are common components in automotive vehicles. One or two joints assembled to the interconnecting shaft form a propeller or drive shaft assembly. The interconnecting shaft is solid or tubular with ends adapted to attach the shaft to a joint or drive unit. Each joint is typically either press fit, splined, or bolted to the interconnecting shaft.

Motor vehicles commonly use propeller or drive shafts to transfer torque from the one input unit to an output unit, e.g. from a front drive unit to a rear axle differential such as in rear wheel and all wheel drive vehicles. Propeller shafts are also used to transfer torque and rotational movement to the front axle differential in four wheel drive vehicles. In particular, two-piece propeller shafts connected by an intermediate joint are commonly used when larger distances exist between the front drive unit and the rear axle of the vehicle. Similarly, inboard and outboard axle drives are commonly used in motor vehicles to transfer torque from a differential to the wheels. The torque transfer is achieved by using a propeller shaft assembly consisting of one or two joints assembled to an interconnecting shaft.

Joint types used include Cardan, Hooke or Rzeppa type universal joints. Typically, Rzeppa type constant velocity joints are employed where transmission of a constant velocity rotary or homokinetic motion is desired or required. Constant velocity joints include tripod joint, double offset joint, and cross groove designs having plunging or fixed motion capabilities. The tripod type constant velocity joint uses rollers or trunions as torque transmitting members and the other constant velocity joint types use balls as torque transmitting members. These types of joints assembled to an interconnecting shaft are applied in inboard axle and outboard axle drives for front wheel drive vehicles, or rear wheel drive vehicles, and on the propeller shafts found in rear wheel drive, all wheel drive, and four-wheel drive vehicles allowing for angular articulation or axial motion.

The interconnecting shaft is a solid or hollow shaft having a constant or variable diameter over its length, and ends typically adapted for coupling to a joint. The interconnecting shaft and the constant velocity joint are assembled to one another. Typically, the interconnecting shaft having a male spline is press fit into the receiving part of the joint having a female spline. A backup-retaining ring may be applied to the shaft to further secure the joint to the shaft. For example, a propeller shaft assembly is formed when a tripod constant velocity joint is assembled to an interconnecting shaft. The interconnecting shaft having, typically, a class 5 spline machined into one end of it. The inner member, tripod body, of a joint has a bore with a mating spline broached into it. The inner member of the joint is then press fit onto the interconnecting shaft and a retaining ring may be placed to insure that the joint part remains on the interconnecting shaft should the interference fit fail or work loose. The spline interface is designed to ensure a positive press load during the process of pressing the inner joint part onto the interconnecting shaft end. Variances from the soft state, before hardening of the inner joint part and interconnecting shaft, spline form are unavoidable as case depth hardness requirements on both components cause spline geometry deformation due to Martensinic micro-structure formation in the case during the hardening process. Residual or hoop stress occurs in the inner joint part after the high interference press fit onto the interconnecting shaft which may affect high cycle fatigue and product life. It would be desirable to have a connection method in which it is not necessary to factor in or over-compensate for the residual stress in the life cycle design analysis. These splined and press fit shaft assemblies are widely used within the automotive industry for connecting a joint to a shaft because of the self centering and alignment accuracy during high production cycles, reliability of the connection while in use, after-market maintainability, and the overall durability of the connection. Other methods of attaching the inner joint part to the interconnecting shaft have consisted of bolted or press fit assemblies, which, however, are more prone to misalignment and imbalance, and are less durable when compared to the splined assembly.

These types of assemblies are considered a non-permanent attachment. A further limitation is that the torque transmitting capability of the propeller shaft is limited by the torque transfer design limit of the interconnecting shaft and inner joint interface for a given design envelope. Therefore, it would be desirable to have a propeller shaft assembly where the inner joint part is not splined, pressed or bolted onto the interconnecting shaft while achieving or exceeding the benefits of the splined coupling.

Each propeller spline shaft assembly requires production procedures of machining, boring, broaching, splining, heat-treating and interference fitting. All of which may add cost and complexity to the manufacturing process. Currently a typical manufacturing process of the splined propeller shaft assembly requires at least: preparing the interconnecting shaft, preparing the inner joint part of the tripod joint, press interference fitting the two parts together, and adding a retaining ring. The manufacturing process of the interconnecting shaft typically is as follows: cropping a bar, facing a bar, centering the bar, turning the bar forming a shaft, spline rolling the shaft end, groove turning the shaft end, induction hardening the shaft, and painting the shaft. The manufacturing process of the inner joint part of the tripod joint is similarly complex: tripod inner joint part forging, core piercing, bore turning, spline broaching, case carburising, hard machining, and bearing assembly. The interference fit procedure introduces the residual stresses in the thin wall of the inner joint part of the tripod body requiring increased design factors to account for the increase in residual stress or decrease torque transfer capability. Increased torque transfer capability by decreasing or eliminating residual stress in the inner joint part would be beneficial. Also, it would be desirable to decrease the cost and complexity of manufacturing the shaft assembly.

It would be advantageous to have the above-mentioned improvements in the tripod joint and interconnecting shaft. Automotive manufactures and suppliers commonly know the tripod constant velocity joint as a GI or AAR type joint. The invention, here below, relates to this type of joint.

### SUMMARY OF THE INVENTION

Accordingly, the present invention is directed toward a propeller drive assembly for use in a vehicle driveline having a unitary construction comprising a tripod body and an interconnecting shaft. In particular, the tripod body, which is the inner joint part of a tripod joint, is welded to the end of an interconnecting shaft. Also, the manufacturing process is simplified where the method of making the unitary tripod shaft involves the additional step of friction welding the constituent parts while eliminating the spline and interference press fitting operations.

A unitary tripod shaft for torque transmission is comprised of an interconnecting shaft and a tripod body welded together to form a propeller shaft assembly. The tripod body has an end co-axially fixed to an end of the interconnecting shaft and includes three equally circumferentially spaced trunions extending therefrom, wherein the tripod body is welded to the interconnecting shaft.

A method of making the unitary tripod shaft includes receiving a tripod body, hardening the tripod body, machining the tripod body, and mounting the tripod body in a fixture. Then, the method continues by receiving an interconnecting shaft, cropping the interconnecting shaft, facing the interconnecting shaft, centering the interconnecting shaft, turning the interconnecting shaft, hardening the interconnecting shaft, mounting the interconnecting shaft in a fixture, welding the interconnecting shaft to the tripod body, and removing the unitary tripod shaft from the fixture.

The present invention has advantages by its simplified manufacturing process and reduced residual stress in the tripod body wall of the unitary tripod shaft. The present invention itself, together with further objects and intended advantages, will be best understood by reference to the following detailed description, taken in conjunction with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention.

In the drawings:

FIG. 1 shows a plan view of a four wheel drive vehicle driveline in which the present invention may be used to advantage.

FIG. 2 shows a half-sectional view of a constant velocity joint assembly comprising a unitary tripod shaft in accordance with one embodiment of the present invention.

FIG. 3 shows a half-sectional view of a unitary tripod shaft in accordance with another embodiment of the present invention.

FIG. 4 shows a sectional view of a tripod body in accordance with an alternative embodiment of the present invention.

FIG. 5 shows a partial view of an interconnecting shaft in accordance with one embodiment of the present invention.

FIG. 6 shows a partial view of an interconnecting shaft in accordance with another embodiment of the present invention.

FIG. 7 is a block diagram showing the method of making a unitary tripod shaft in accordance with the present invention.

### DETAILED DESCRIPTION OF THE INVENTION

In the following description, various operating parameters and components are described for one or more constructed embodiments. These specific parameters and components are included as examples and are not meant to be limiting.

While the invention is described with respect to an apparatus having an unitary joint and interconnecting shaft for use in a vehicle, the following apparatus is capable of being adapted for various purposes including automotive vehicles drive axles, motor systems that use a propeller shaft, or other vehicles and non-vehicle applications which require propeller shaft assemblies for torque transmission.

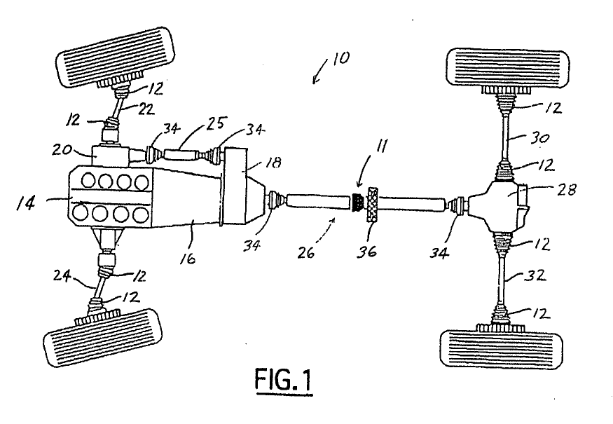

Referring now to FIG. 1, there is shown a plan view of four wheel drive vehicle driveline 10 wherein a unitary tripod shaft 11 of a propeller shaft assembly 26 in accordance with the present invention may be used to advantage. The driveline shown in FIG. 1 is typical for a four wheel drive vehicle, however, it should be noted that the unitary tripod shaft 11 of the present invention can also be used in rear wheel drive only vehicles, front wheel drive only vehicles, all wheel drive vehicles, and four wheel drive vehicles. The vehicle driveline 10 includes an engine 14 that is connected to a transmission 16 and a power takeoff unit such as a transfer case 18. The front differential 20 has a right hand side shaft 22 and left hand side shaft 24, each of which are connected to a wheel and deliver power to the wheels. On both ends of the right hand front half shaft 22 and the left hand front half shaft 24 are constant velocity joints 12. A front propeller shaft assembly 25 connects the front differential 20 to the transfer case 18. A propeller shaft assembly 26 connects the transfer case 18 to the rear differential 28, wherein the rear differential 28 includes a rear right hand side shaft 30 and a rear left hand side shaft 32, each of which is connected to a respective wheel. Constant velocity joints 12 are located on both ends of the side shafts 30, 32 that connect the rear wheels to the rear differential 28. The propeller shaft assembly 26, shown in FIG. 1, is a two-piece propeller shaft. Each end includes a rotary joint 34 that may comprise a Cardan joint or several types of constant velocity joints. The propeller shaft assembly 26 uses the unitary tripod shaft 11 in accordance with the present invention to advantage for torque transmission. Likewise, the unitary tripod shaft 11 of the present invention can be used to advantage in any of the other joint 12, 34 and shaft 22, 24, 25, 26, 30, 32 assemblies.

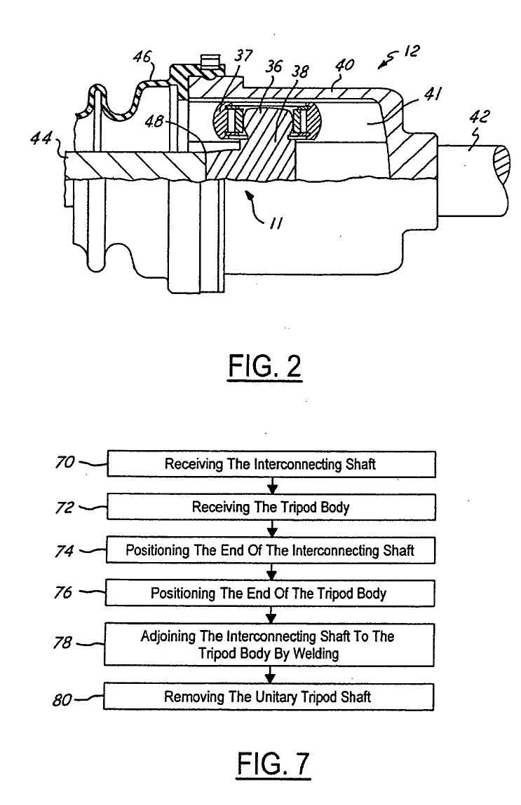

FIG. 2 shows a half-sectional view of a constant velocity joint assembly 12 comprising a unitary tripod shaft 11 in accordance with one embodiment of the present invention. The unitary tripod shaft 11 comprises an interconnecting shaft 44 welded to a tripod body 38 at a weld interface 48 in accordance with the present invention. The interconnecting shaft 44 and the tripod body 38 are shown as being solid at the weld interface 48 in this embodiment. The tripod body 38 has three trunions 36. Each of the trunions 36 may be coupled to a roller 37. The interconnecting shaft 44 may be any one of the shafts as shown in FIG. 1 or may be a shaft used in any other application requiring a tripod joint.

The constant velocity joint assembly 12 of this embodiment includes a boot seal 46, rollers 37, an unitary tripod shaft 11 and an outer joint part 40. The outer joint part has longitudinally extending tracks 41 which may be coupled to a shaft 42 or any other interface means such as a bolted, welded, threaded, or unibody coupling. The unitary tripod shaft 11 coupled to the rollers 37 is articulately coupled to the outer joint part 40. The outer joint part 40 is coupled to the boot seal 46. The boot seal 46 is coupled to the unitary tripod shaft 11 (not shown in FIG. 2).

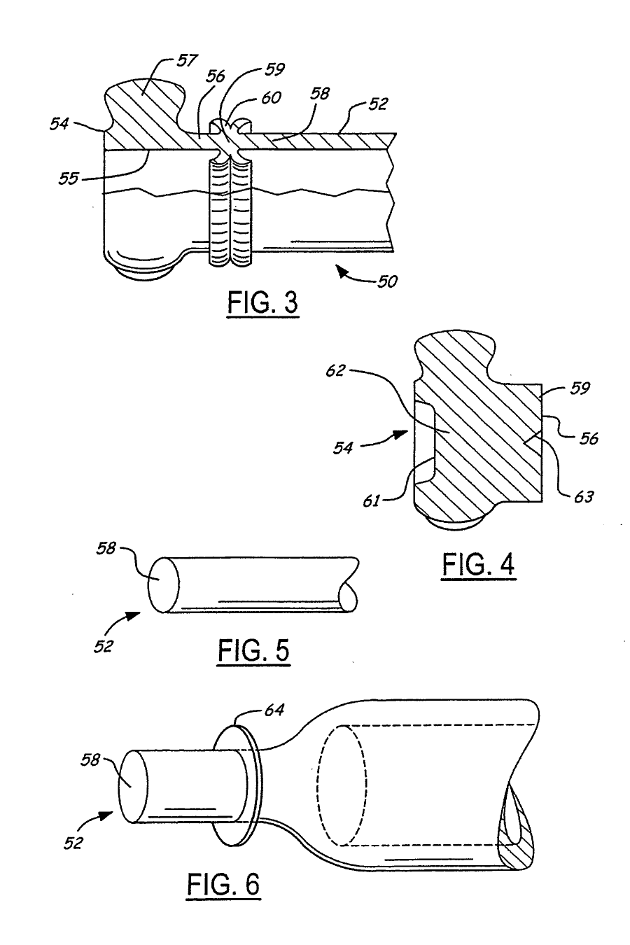

FIG. 3 shows a half-sectional view of a unitary tripod shaft 50 in accordance with another embodiment of the present. The unitary tripod shaft 50 includes an interconnecting shaft 52 welded to a tripod body 54. In this embodiment, the weld process was accomplished by fiction welding an end 56 of the tripod body 54 co-axially to an end 58 of the interconnecting shaft 52. The welding process may involve other weld processes known in the art, such as laser welding. Friction welding results in a mushroom-shaped collar 60 that may be trimmed back as necessary. The embodiment envisions an untrimmed collar 60 when clearance is obtainable and interference is avoidable with other joint parts when the unitary tripod shaft 50 is assembled. Otherwise, the collar 60 may be trimmed as required. This embodiment shows the tripod body 54 as having bore 55, three equally circumferentially spaced trunions 57 extending therefrom, and an end 56 extended axially outward from the tripod body 54 forming a skirt 59 having a nominal outer diameter, a nominal inner diameter and a face. The end 58 of the interconnecting shaft 52 shown here having a nominal outer diameter, a nominal inner diameter and a face, which is axially symmetrical to that of the end 56 of the tripod body 54 which provides for optimal friction welding and heat generation conditions when the pieces are coupled together. The interconnecting shaft 52 and the tripod body 54 need not have a bore, matching bores or matching outer diameters. The interconnecting shaft 52 or the tripod body 54 may have a bore or may be solid. The end face of each part should be prepared, e.g. flat, tapered or notched, in accordance with the welding process used to join them together as is known by one skilled in the art.

The skirt 59 may have a constant diameter, e.g., cylindrical in nature or a cylindrical skirt, or it may have an increasing or decreasing taper making the end 56 adaptable to mating with the end 58 of the interconnecting shaft 52.

FIG. 4 shows a sectional view of a tripod body 54 in accordance with an alternative embodiment of the present invention. The tripod body 54 is shown having a solid body and a skirt 59 as its end 56. The other axial end of the tripod body 54 may have a recess 61 allowing for reduced weight and material savings, though the recess 61 is not necessary. Alternatively, the inner body 62 may be hollow or solid. The end 56 of the tripod body 54 is formed axially and extending as a skirt 59. The axial length of the skirt 59 is dependent upon design parameters and can vary from little or no length to an extended length. The length of the skirt 59 will be of sufficient length so that the heat-affected zone during the weld process will not have an adverse affect upon operating characteristics of the tripod body 54 and trunions 57. The skirt 59 as shown is solid having a cylindrical shape and a centering hole 63 to facilitate manufacturing. The skirt 59 may be hollow or solid and need not have a cylindrical shape.

FIG. 5 shows a partial view of an interconnecting shaft in accordance with one embodiment of the present invention. The interconnecting shaft 52 is typically cylindrical in its length, however it may be of other shapes acceptable for torque transmission purposes. The interconnecting shaft 52 may be hollow, partially hollow, or solid. The end 58 of the interconnecting shaft 52 may be symmetrical for mating to the end 56 of the tripod body 54. The end 58 of the interconnecting shaft 52 may have a different shape than that of the mating end 56 of the tripod body 54.

FIG. 6 shows a partial view of an interconnecting shaft in accordance with another embodiment of the present invention. FIG. 6 shows an interconnecting shaft 52 having a solid end 58 for welding with a varying shape over the shaft's 52 length and is part tubular. Optionally, a boot plate 64 is shown coupled to the shaft 52 adaptable to sealingly connect a boot seal to the shaft 52 after joint assembly. The boot plate 64 may be desirable in situations where a boot seal cannot slip past the tripod body and onto the shaft, cannot be slid over the opposite end of the shaft, or is not pre-assembled onto the shaft prior to welding the tripod body to the interconnecting shaft.

FIG. 7 is a block diagram showing the method of making a unitary tripod shaft in accordance with the present invention. The method of making the unitary tripod shaft involves the steps of receiving 70 the interconnecting shaft, receiving 72 the tripod body, positioning 74 the end of the interconnecting shaft, positioning 76 the end of the tripod body, and joining 78 the interconnecting shaft to the tripod body by welding, and removing 80 the unitary tripod shaft. The joining 78 process may be accomplished by using friction, laser and other weld methods. For friction welding, the joining 78 process will also include a sub-process of spinning the tripod body or interconnecting shaft while applying an axial load as is known in the art. Although the method of making is listed in a particular order, the steps can be taken in many different orders and it is not to be inferred that the order given is the only possible order for manufacturing.

Additional steps of manufacturing may be incorporated independently or jointly into the method of making a unitary tripod shaft. The tripod body can undergo a process of hardening, wherein the surface of the tripod body is hardened using a compatible hardening processes, such as carburising. The tripod body can be machined or finish machined wherein the trunions and other tripod body surfaces are machined to the design dimensions and surface finished. The trunions of the tripod body may be finished ground using a grinding process. Also, an assembling process may be incorporated where there are bearings and rollers to be assembled onto the trunions.

Furthermore, the following steps for the interconnecting shaft may be incorporated independently or jointly into the method of making a unitary tripod shaft: cropping the interconnecting shaft to a dimension ready for processing; facing the interconnecting shaft to prepare the ends for welding; centering the interconnecting shaft to align with the tripod body during the weld process; hardening the interconnecting shaft using a compatible process such as induction hardening to making the shaft stronger; painting the interconnecting shaft creating a protective layer using known painting methods such as powder painting; and assembling a roll boot onto the interconnecting shaft prior to the step of welding in order to provide a roll boot for sealing of the assembled joint when other means of boot assembly would be inoperative.

From the foregoing, it can be seen that there has been brought to the art a new and improved propeller shaft assembly. While the invention has been described in connection with one or more embodiments, it should be understood that the invention is not limited to those embodiments. On the contrary, the invention covers all alternatives, modifications, and equivalents as may be included within the spirit and scope of the appended claims.

1. A unitary tripod shaft for torque transmission, comprising:
an interconnecting shaft; and
a tripod body having an end co-axially fixed to an end of the interconnecting shaft and comprising three equally circumferentially spaced trunions extending therefrom, wherein the tripod body is welded to the interconnecting shaft.

2. The unitary tripod shaft according to claim 1, wherein the tripod body is friction welded to the interconnecting shaft.

3. The unitary tripod shaft according to claim 1, wherein the tripod body is laser welded to the interconnecting shaft.

4. The unitary tripod shaft according to claim 1, wherein the end of the tripod body is axially symmetrical to the end of the interconnecting shaft.

5. The unitary tripod shaft according to claim 1, wherein the end of the interconnecting shaft is solid.

6. The unitary tripod shaft according to claim 1, wherein the end of the tripod body is a skirt.

7. The unitary tripod shaft according to claim 1, wherein the tripod body has a recess.

8. The unitary tripod shaft according to claim 1, wherein the body has an inner bore.

9. A method of making a unitary tripod shaft for torque transmission, comprising:
providing an interconnecting shaft;
providing a tripod body;
positioning an end of the interconnecting shaft;
positioning an end of the tripod body relative to the end of the interconnecting shaft; and
joining the interconnecting shaft end to the tripod body end by welding.

10. A method of making a unitary tripod shaft according to claim 9, further comprising hardening the tripod body.

11. A method of making a unitary tripod shaft according to claim 9, further comprising machining the tripod body.

12. A method of making a unitary tripod shaft according to claim 9, wherein the tripod body includes three circumferentially spaced trunions, and the method further comprises grinding the trunions on the tripod body.

13. A method of making a unitary tripod shaft according to claim 12, further comprising assembling bearings and rollers onto the trunions.

14. A method of making a unitary tripod shaft according to claim 9, further comprising cropping the interconnecting shaft.

15. A method of making a unitary tripod shaft according to claim 9, further comprising facing the interconnecting shaft.

16. A method of making a unitary tripod shaft according to claim 9, further comprising centering the interconnecting shaft.

17. A method of making a unitary tripod shaft according to claim 9, further comprising hardening the interconnecting shaft.

18. A method of making a unitary tripod shaft according to claim 9, further comprising painting the interconnecting shaft.

19. A method of making a unitary tripod shaft according to claim 9, further comprising assembling a roll boot onto the interconnecting shaft.

20. A unitary tripod shaft assembly for a vehicle comprising:
a shaft;
an outer joint part comprising three longitudinally extending tracks, said outer joint part being connected to said shaft;
an interconnecting shaft; and
a tripod body having an end co-axially fixed to an end of said interconnecting shaft and comprising three trunions extending therefrom, wherein said tripod body is welded to said interconnecting shaft and the trunions are disposed within the tracks of said outer joint part.
